(19) United States
(12) Patent Application Publication
(10) Pub. No.: US 2004/0165525 A1
(43) Pub. Date: Aug. 26, 2004

(54) System and method for network redundancy

(75) Inventor: Kevin Burak, N. Easton, MA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Invensys Systems, Inc., Foxboro, MA

(21) Appl. No.: 10/775,633

(22) Filed: Feb. 10, 2004

Related U.S. Application Data
(60) Provisional application No. 60/446,330, filed on Feb. 10, 2003.

(51) Int. Cl. H04L 12/56; H04J 3/14

(52) U.S. Cl. 370/228; 370/237; 370/401

(57) ABSTRACT

An Ethernet communications redundancy system provides network access redundancy and end-to-end error detection and recovery, useful to Industrial control applications as well as other types of applications. In embodiments of the invention, an additional data link driver is provided between the network stack and the IEEE 802.3 MAC PHY. Internet Protocol or proprietary applications will still run without modification or enhancement since the additional layer is not exposed as such to higher layers. Embodiments of the invention allow the use of commercial off the shelf (COTS) protocol stacks (e.g. IP, Ethernet) and are independent of any employed network redundancy.

### RELATED APPLICATION

This application is related to and claims priority to U.S. Provisional Application No. 60/446,330, entitled Industrial Ethernet Redundancy Specification, filed Feb. 10, 2003, which is herein incorporated by reference in its entirety for all that it teaches without exclusion of any part.

### FIELD OF THE INVENTION

This invention relates generally to networking technologies and, more particularly, relates to a system and method for providing network redundancy via multihomed devices.

### BACKGROUND

Ethernet LANs were first wired using coaxial cables with each station tapping into the cable. Since this architecture represented a shared single collision domain (single cable shared by all devices on the network), performance and fault-isolation problems resulted. As Ethernet LANs continued to grow, a more structured approach, called star (or hub-and-spoke) topology, was used where all attaching devices were linked to a repeater. This helped with respect to fault isolation and in addition provided a more organized methodology for expanding LANs.

Ethernet subsequently evolved to employ switching. Switched Ethernet has broken up the collision domains allowing for simultaneous switching of packets between the switch's ports. These switches can connect two types of Ethernet segments (shared and dedicated) interchangeably. Shared (multiple-station) segments or dedicated (single-station) segments can be attached to any port on the switch. Single-station segments are generally used, allowing switches to isolate faults between their ports. Another performance enhancement that switched Ethernet enjoys is IEEE802.3x, which has full-duplex flow control. IEEE802.3x is a point-to-point protocol, not a shared medium protocol. Thus, every IEEE802.3x node has its own dedicated switch port.

Another fundamental problem with standard Ethernet is the handling of multiple faults. Industrial grade Ethernet uses several layers of redundancy and industrialhardened components to handle multiple faults. The several layers of redundancy primarily involve doubling up on physical wiring, so that a redundant path is available if the path fails. There exist three primary methods of wiring a network so that a redundant path can be used if the active one fails: (1) Spanning Tree or Rapid Spanning Tree prevents redundant traffic paths but still allows a redundant network, (2) Ring Redundancy—functionally behaves like Spanning Tree, but the ring splits into arms if it fails, and (3) Link Aggregation (trunking)—supports direct port-to-port redundant communications paths.

A problem with many of these Ethernet redundancy solutions is that network (e.g. IP) protocols can only bind with one data link address at a time. This forces applications to maintain two network addresses and their routes. In March of 2000, a new standard called IEEE 802.3ad Link Aggregation emerged. IEEE 802.3ad Link Aggregation allows one network (e.g. IP) address to use multiple physical ports. However, conformant Media Access Controller (MAC) bridges will not forward the link aggregation setup and control protocol. Thus, switches will never forward Link Aggregation setup messages from station to station. For end-to-end redundancy, this means that these stations must be directly connected to each other for link aggregation to work.

The previously discussed solutions have typically been used for switch (network component hardware) redundancy to facilitate automatic recovery by finding an alternative path(s) in case one path fails. However, these standards fail to address, for applications, redundant network access, and end-to-end fault detection, with automatic recovery that is independent of any network healing such as pursuant to spanning tree techniques. Industrial applications often require that the associated industrial networks have redundancy support with a minimum of two physical (PHY) ports for network access. Devices having these connections are called Multihomed devices.

With Multihomed devices, fault recovery is not automatic, and there are two predominant approaches to fault recovery. In particular, the first technique entails establishing two IP stacks and letting the application choose which route (fault recovery) to use. The second technique entails configuring static routes, however, this is tedious, time consuming, creates single points of failures, and is prone to configuration errors. Moreover, there exist a great number of legacy applications written for specific application programming interfaces (APIs), such as the Berkley Sockets, that only use a single IP stack. And of course, software vendors are understandably reluctant to rewrite their applications to support a large amount of APIs.

### BRIEF SUMMARY OF THE INVENTION

The industrial manufacturing industry is undergoing a shift from proprietary network solutions to commercial off the shelf (COTS) network solutions. The primary reason for the shift to COTS components such as bridges, switches, and Network Interface Cards (NIC) is that the use of COTS components offers users a wide array of choices on competitive terms. Ethernet offers a COTS solution, as an open standard for users which is not constrained by proprietary architectures. The development of switches and hubs has also resulted in Ethernet having levels of determinism comparable to proprietary networks.

By moving to a COTS network (e.g. Ethernet and the IP protocol suite), the industrial manufacturing industry not only saves infrastructure costs, but can also integrate real-time manufacturing information with back-office systems. This allows manufacturers to pull more information from the factory floor and feed it into enterprise applications (e.g. inventory control and asset management). It can also enable a company to perform remote monitoring and diagnostics of equipment and processes.

Despite all of the aforementioned advances in industrial networking, there remains a need for manufacturing applications to ensure that these networks continually maintain high bandwidth, low delay, fault tolerance, fault recovery, and security.

The present invention is directed to a technique for providing network access redundancy and end-to-end error detection and recovery that Industrial control applications need. In addition, the deployment and operation of the invention are generally automatic and transparent to applications in embodiments of the invention. The industrial redundant Ethernet network architecture of embodiments of the invention allows the use of commercial off the shelf (COTS) protocol stacks (e.g. IP, Ethernet) and is independent of any employed network redundancy. Embodiments of the invention provide an additional data link driver between the network stack and the IEEE 802.3 MAC PHY. Internet Protocol or proprietary applications will still run without modification or enhancement. In particular, the network will look and feel like any other standard Ethernet network to the application. Therefore, no changes are required to existing higher-layer protocols or applications that use these. It also does not impose any changes to the 802.3 MAC.

Additional features and advantages of the invention will be made apparent from the following detailed description of illustrative embodiments which proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is schematic network diagram showing multihomed devices connected over a redundant switched Ethernet network according to an embodiment of the invention;

FIG. 2 is a selection of schematic diagrams showing a progression of network configurations according to an embodiment of the invention;

FIG. 3 is a selection of schematic diagrams showing a progression of network configurations according to a further embodiment of the invention;

FIG. 4 is a stack architecture diagram showing additional components according to an embodiment of the invention for accomplishing communications redundancy;

FIG. 5 is a multiple stack architecture diagram showing communications paths according to an embodiment of the invention;

FIG. 6 is a multiple stack architecture diagram showing communications paths according to a further embodiment of the invention;

FIG. 7 is a multiple stack architecture diagram showing communications paths according to yet a further embodiment of the invention; and

FIG. 8 is a flow chart illustrating steps taken according to an embodiment of the invention to switch communications stacks.

### DETAILED DESCRIPTION

The invention pertains to industrial and other networks and to a novel system and method for providing an Ethernet network with higher reliability. Herein, the invention will generally be described with reference to operations performed by one or more computers, unless indicated otherwise. It will be appreciated that such acts and operations comprise manipulation by the processing unit of the computer of electrical signals representing data in a structured form, transforming the data or maintaining it at locations in the memory system of the computer to alter the operation of the computer in a manner well understood by those skilled in the art. Moreover, it will be appreciated that many of the functions and operations described herein are executed by a computer or other computing device based on computer-executable instructions read from a computer-readable medium or media. Such media include storage media, such as electrical, magnetic, or optical media, as well as transportation media, such as a modulated electrical signal on a carrier medium.

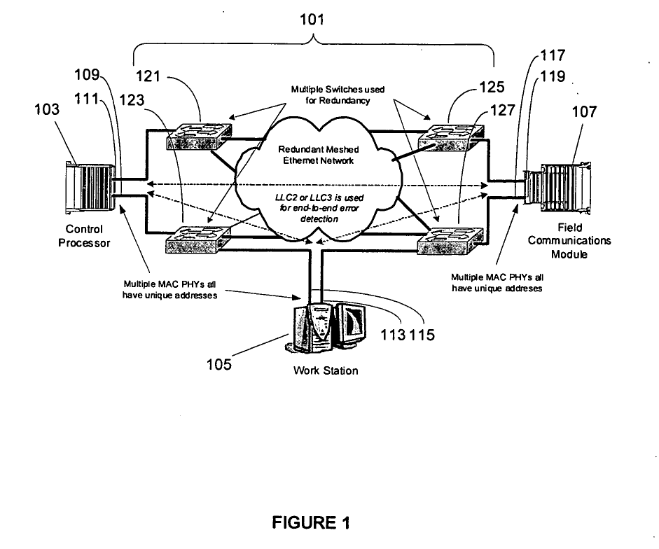

FIG. 1 is a schematic network diagram showing a general network environment for implementing various embodiments of the invention. A control processor 103 (“control module”), a workstation 105, and a field communications module 107 (“field module”) are shown linked via a redundant switched Ethernet network 101. It will be appreciated that any number and types of machines may be interconnected, and the illustrated configuration is merely an example. The Ethernet redundancy provided in an embodiment of the invention is supplied via multiple ports (PHYs) for its redundancy solution. In particular, multiple IEEE 802.3 PHYs on each device 103, 105, 107 provide redundant network port access. As shown, control processor 103 has multiple PHYs 109 and 111, workstation 105 has multiple PHYs 113 and 115, and field communications module 107 has multiple PHYs 117 and 119. Note that the illustrated embodiment of the invention also uses redundant switches 121, 123, 125, and 127. In an embodiment of the invention, the network 101 further comprises one or more IEEE 802.1d compliant bridges.

The redundant network ports 109, 111, 113, 115, 117, 119 allow communications via the network 101 to continue even in the event that there is a fault with respect to access to the network or a broken path somewhere within the network. Each PHY is associated with its own individual network protocol stack, and is further associated with a unique set of network (e.g. IP) and MAC addresses. For each machine having multiple PHYs, one protocol stack and its set of associated (network and MAC) addresses is assigned as the primary communications stack. It is this communication stack that has redundant end-to-end network communications. In operation, its stack includes a network protocol (e.g. the IP suite), LLC type 2 or 3, and the Ethernet (IEEE 802.3) protocol. Preferably, the primary communications stack is always assigned to a non-faulted PHY.

The remaining PHYs on each machine are employed to provide network access redundancy to the primary stack as well as alternative communications. These other protocol stack(s), referred to herein as alternative or alternate stacks, will be assigned to the remaining PHY(s). Alternative protocol stacks include the network (e.g. the IP) suite and data link (Ethernet) protocols. Such alternative stacks may be used for network communications and for verifying their PHY's network access for latent faults. These stacks can only detect link faults (i.e. the absence of an IEEE 802.3 port link) and share a PHY for its redundancy.

When the primary stack detects a fault (link or end-to-end) on its current bound PHY, a data link protocol layer employs an alternate port based on physical link status information received from its ports and end-to-end connectivity status received from a reliable Logical Link Control (LLC) Type 2 or 3. In particular, the data link protocol layer will preferably move the primary stack to a non-faulted PHY. The non-faulted PHY, which the primary stack is being moved to, already has an alternative stack bound to it. This alternative stack has the option of moving to the faulted PHY or not. If the fault was an end-to-end fault (discovered by LLC2 or 3), then the alternative stack will preferably switch PHYs with the primary stack in an embodiment of the invention. If the alternative stack cannot detect end-to-end faults with its data link layer, then such is not a fault to this stack.

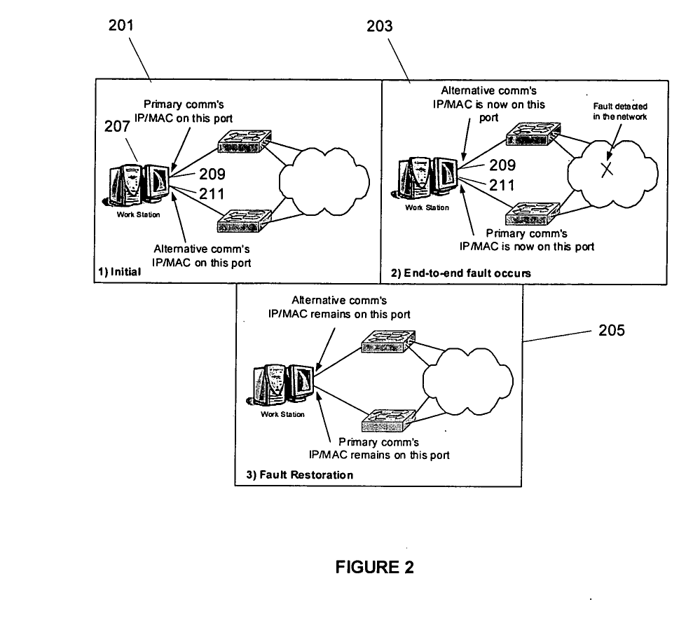

FIG. 2 illustrates a sequence of events occurring upon detection and subsequent remediation of an end-to-end fault according to an embodiment of the invention. In particular, within box 201 is shown a network configuration in an initial unfaulted condition. It can be seen that workstation 207 is redundantly connected to a switched Ethernet network via ports 209 and 211. Port 209 has been assigned as the primary, and port 211 as the alternate.

In box 203, an end-to-end network fault is detected from the primary port 209. End-to-end faults are identified by the absence of data-link acknowledgements for a predetermined amount of time as well as a predetermined number of retries in an embodiment of the invention. As can be seen, the roles of primary port and alternate port are switched in response, such that the port 211 is now assigned as the primary and port 209 is assigned as the alternate. In box 205, the fault has been resolved. However, in this embodiment of the invention, the port assignments remain as they last were, namely port 211 assigned to be the primary and port 209 assigned to be the alternate. This is because there is typically no reason in a no-fault situation to prefer one port over the other.

When a link fault, as opposed to an end-to-end fault, is detected on the primary stack's PHY, the primary stack will also move to a non-faulted PHY in an embodiment of the invention. Link faults are detected by the absence of an IEEE 802.3 port link. The alternative stack already bound to that non-faulted PHY may be treated in one of two ways. One option is that it may simply exchange PHYs with the primary stack, so that the alternative stack will be on the PHY with the detected link fault. Alternatively, the alternate stack may stay and share the non-link faulted PHY with primary communications stack, so that there is no stack on the PHY with the detected link fault.

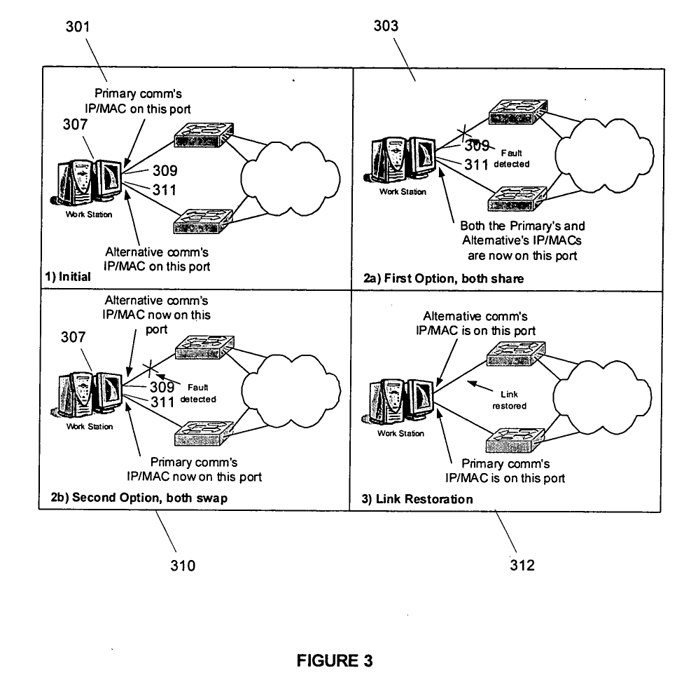

FIG. 3 shows a progression of network configurations to illustrate the above principles. The network architecture of the illustrated example comprises a workstation 307 with redundant physical connections 309, 311 to a switched Ethernet network. In the first box 301, a situation is illustrated in which no faults are known, and port 309 is assigned as primary and port 311 is assigned as alternate. In the situation shown in box 303, representing a first alternative, a link fault has been detected in the link to port 309, the currently assigned primary. As a result, the primary has moved to port 311, and the alternate stack remains assigned to that same port, “sharing” it.

In the alternative fault remediation scheme shown in box 310, not only does the primary stack bind to the non-faulted port 311, but the alternate stack binds to the faulted port 309. Finally, as shown in box 312, the fault is corrected, however, the port assignments need not change at that point. However, in the embodiment of the invention wherein the primary and alternate stacks share a non-faulted port, it will sometimes be desirable that one of the stacks shifts back to the unoccupied port once the fault is addressed.

In overview, switching PHYs on faults, provides applications with much needed required network access redundancy. By building network access redundancy in the PHY and data link layers as will be described in greater detail below, the described Ethernet redundancy technique allows existing application software to operate without any changes. This transparency is achieved by automatically forwarding the application's network traffic out different PHYs as needed.

Certain implementation details with regard to embodiments of the invention will now be described in greater detail. In overview, the described Ethernet redundancy technique works by interposing an additional functional layer between the Ethernet (802.3) MAC PHY and the network protocols (e.g. IP suite). End stations (workstations, control modules, etc) will minimally have at least two Ethernet ports (PHY), although any machine may also have more than two Ethernet ports. For a given machine, each PHY is preferably connected to a different Ethernet switch to obtain network switch redundancy. As will be shown below, a link selector pre-selects a non-faulted Ethernet PHY for the primary stack. The described Ethernet redundancy solution contains three main recommendations: Multiple IEEE 802.3 MAC PHYs should be used to provide redundant network access as well as link access fault detection; a data link protocol (IEEE 802.2 Logical Link Control Type 2, or 3, or equivalent) should be used to provide end-to-end error detection; and, a link selector should be used to provide the ability to swap PHY links transparently to the higher level protocols.

LLC Type 2 (LLC2) provides a connection-oriented service. The LLC2 service establishes logical connections between sender and receiver and is therefore connection oriented. LLC Type 3 (LLC3) provides an acknowledged connectionless data-link service. Although LLC3 service supports acknowledged data transfer, it does not establish logical connections. If the packet was not received, then the station retransmits the data packet. In either case, both LLC types only validate if a packet is received and will try again on the same network port if it previously failed.

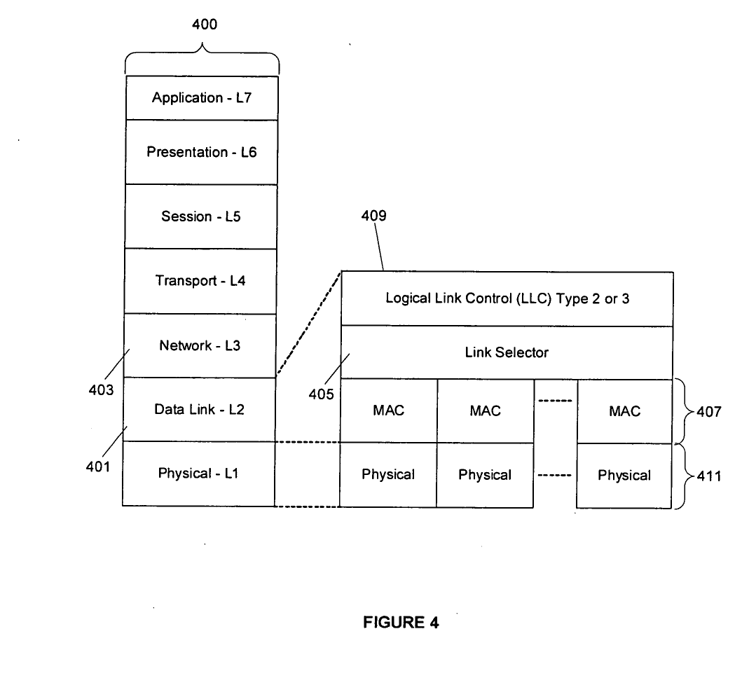

As shown in FIG. 4, the described Ethernet redundancy solution is located primarily in the data link layer (L2) 401 of the 7-layer OSI model 700. All layers at and above the network layer (L3) 403 remain unchanged by the redundancy solution described herein. Within the data link layer 401, the link selector 405 is located above the 802.3 MAC PHYs 407. The Logical Link Control (LLC) 409 is a located above the link selector 405. The link selector sublayer 405 hides which actual PHY 411 is being used from higher layers, thus providing application transparency to the network redundancy solution. Note that the functional block view of FIG. 4 does not necessarily reflect the actual protocol stack layout.

When a station does transmit a packet, it is done in a normal data communication fashion (e.g. a Berkley socket call, etc.). The transmitted packet moves down the protocol stack to the network layer 403, which then passes the packet to the Logical Link Control (LLC type 2 or 3) 409. The LLC (type 2 or 3) 409 ensures that the packet will be delivered error free in a timely fashion. In an embodiment of the invention, the LLC (type 2 or 3) 409 used will follow the procedures specified in the Logical Link IEEE Standard. The LLC 409 then calls the link selector 405. The link selector 405 will then pass the packet to the chosen primary MAC PHY for transmission.

Again, the 802.3 MAC PHYs 407 provide the link detection to the switches. The link selector 405 provides higher level protocols and applications with redundant links to a COTS network by transparently selecting a non-faulted PHY to transmit and receive on. It also provides a single MAC address for higher layer protocols to use. The LLC (type 2 or 3) 409 provides the end-to-end error detection. If a failure occurs, the link selector 405 will choose an alternative link for network communications.

Due to this architecture, network applications need not be aware of or otherwise accommodate the Ethernet redundancy solution described herein and thus do not need to be modified to reap the benefits provided by this novel architecture. Instead, they simply call their network APIs (e.g. Berkley Sockets) as they normally do. In addition, network stacks also do not need to be modified. They will behave as any MAC client does. The link selector 405 will allow network stacks (e.g. IP) to use multiple PHY ports for redundancy. Since the network stack is unaware of the link selector 405, no changes are needed for the network stack.

The LLC sublayer 409 sits on top of the link selector sublayer 405. The IEEE 802.2 standard defines the LLC sublayer 409 to be topology independent. Using LLC Type 2 or 3, it provides a connection-oriented or a connectionless data transfer respectively. The main function of the LLC 409 is to provide end-to-end error detection between networked stations. If a non-recoverable error is detected (e.g. successive retransmissions fail), then the LLC 409 will notify the link selector 405 that its primary communications had an end-to-end failure and requires a backup PHY.

LLC service Type 2 (LLC2) is a connection-oriented data transmission. LLC2 requires that a logical connection be established between the source and destination stations. The source station establishes a connection when the first LLC PDU is sent. When the destination host receives the LLC PDU, it responds with the control message “LLC PDU,” which is simply a connection acknowledgement. When a connection is established, data can be sent until the connection is terminated. LLC command and LLC response LLC PDUs are exchanged between the source and destination during the transmission to acknowledge the delivery of data, establish flow control, and perform error recovery if needed.

LLC service Type 3 (LLC3) is Acknowledged Connectionless. PDUs are exchange between stations without the establishment of a data link connection. In the LLC3 sublayer, each command PDU receives an acknowledgement PDU. Though the source station may retransmit a command PDU for recovery, it will not send a new PDU to a destination from the higher layers if a previously sent PDU to the same destination has not yet been acknowledged. For further information, the reader is referred to § 4 of the IEEE Std. 802.2 Part 2: Logical Link Control (1997), which document is herein incorporated by reference in its entirety.

As noted, the link selector 405 is positioned between the IEEE 802.3 MAC PHYs and the LLC (type 2 or 3) 409. The link selector 405 sends and receives MAC client (LLC and non-LLC) data to and from the active 802.3 MAC PHY links. The link selector's 405 primary purpose is to map protocol stacks to the appropriate PHYs 411 during live operation. It also hides the mapping of the PHYs by exposing only a single MAC interface per PHY to the higher layers at anytime.

If all PHYs are fault free, then the PHY chosen for the primary communications stack may have a preference weight or it may be entirely arbitrary. Once the primary stack is bound to a non-faulted PHY, the remaining PHYs will be bound to the alternate communication stack or stacks. Once all communications stacks are bound, they will remain bound to their PHYs until the primary communications stack has detected a fault. If an alternate communications stack is configured for link redundancy, it will remain bound until a link failure has been detected on its PHY in an embodiment of the invention.

The link selector 405 also maintains data as to whether a particular destination is considered reachable or not (via detection of end-to-end faults). A destination is considered unreachable if the primary stack has tried all its alternate PHYs and still could not communicate with that destination. In an embodiment of the invention, once a destination is marked unreachable, the link selector 405 will not swap or share PHYs on that destination's behalf. When a previously unreachable destination can be communicated with on its currently mapped PHY, then it will be again be allowed to swap or share a PHY upon a subsequent end-to-end fault detection. This provides needed network access redundancy independently of any network healing or redundancy.

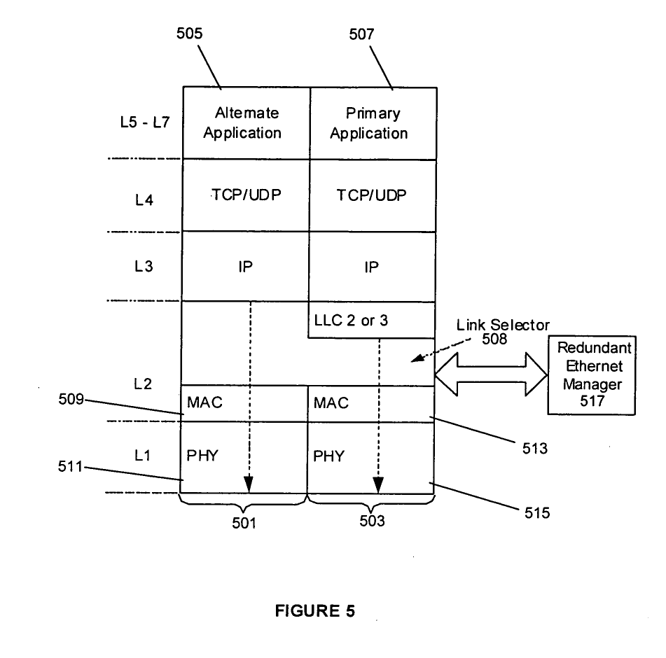

FIG. 5 illustrates via a corn stack model the nonfault binding and data flow in the system. As can be seen from the figure, the model contains both a primary 503 and alternate stack 501 (both stacks in this regard will be referred to as including layers L3-L7 only). A primary application 507 is associated with the primary stack 503, and an alternate application 505 is associated with the alternate stack 501. During nonfault operation, the applications 505, 507 are bound to their respective stacks 501, 503. In this mode, communications relative to the primary application 507 occur via MAC layer 513 and PHY layer 515, whereas communications relative to the alternate application 505 occur via MAC layer 509 and PHY layer 511.

In an embodiment of the invention, when a fault (link or end-to-end) occurs with the primary stack 503, the link selector 508 will trade PHYs with the alternative stack, whose PHY does not have a link fault. To accomplish the exchange, the link selector 508 will unbind the primary and alternate stacks 503, 501 from their respective PHYs 515, 511. The stacks 503, 501 are then rebound to each other's PHYs. The non-faulted PHY's MAC address is then overwritten with the primary's MAC address. Conversely, the faulted PHY's MAC address is overwritten with the alternate's MAC address. Once the stacks have been swapped and the MAC addresses are assigned to the appropriate PHYs, the link selector 508 may indicate this event to a redundant Ethernet manager (REM) 517, which will be described in greater detail below. A broadcast packet is also sent out of their new respective PHYs to inform switches about the availability and location of the primary and alternate MAC addresses. In this mode, a fault detected on an alternative stack will not cause a PHY swap, the alternative stack remaining instead on the faulted PHY.

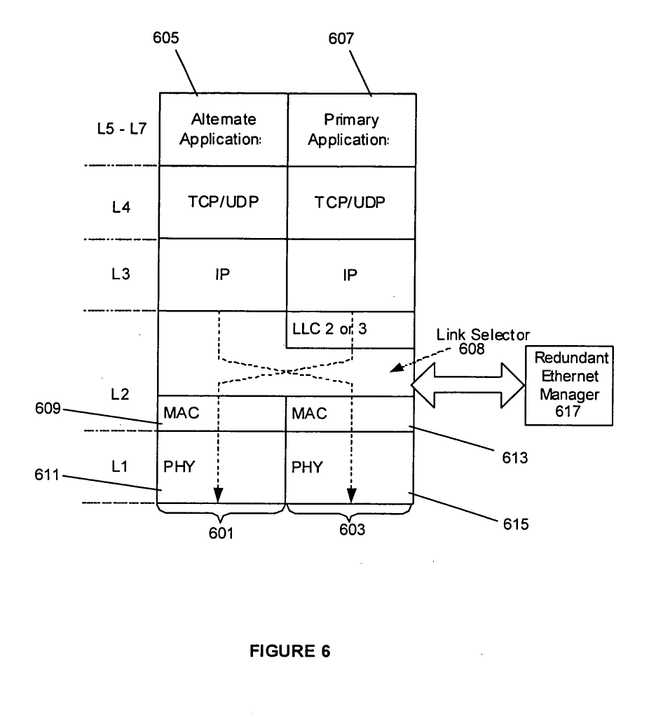

The configuration of the stack and related entities in this mode of operation, i.e. after a swap, is shown in FIG. 6. It can be seen that the primary application 607 and associated stack 603 (i.e. layers 3-7) are now communicating via the MAC layer 609 and PHY layer 611 previously utilized by the alternate application 605. Likewise, the alternate application 605 and associated stack 601 (i.e. layers 3-7) are now communicating via the MAC layer 613 and PHY layer 615 previously utilized by the primary application 607.

In another mode of fault remediation according to an embodiment of the invention, two stacks my share a PHY layer. For example, PHY sharing preferably occurs when a link failure occurs and the alternative stack requires link redundancy. Though the alternate stack cannot detect end-to-end faults, it can detect link failures. So when a link failure occurs on either the primary or alternative's PHY, the link selector will unbind the stack from the PHY with the link fault and bind it to a non-faulted PHY (e.g. the other PHY in the case of two PHYs). This PHY typically will already have a stack bound to it. The non-faulted PHY is then programmed with the second MAC address. If the PHY cannot be programmed with the two requisite MAC addresses, the 802.3 specification allows the PHY to receive a source MAC address from the stack and it will transmit accordingly. To receive packets properly on a PHY that cannot be programmed with two MAC addresses, the PHY is put into promiscuous mode. Once the PHY is being shared, a broadcast packet with the moved MAC address will be transmitted to inform switches about its availability and location. Once completed, the link selector will indicate this event to the REM 617.

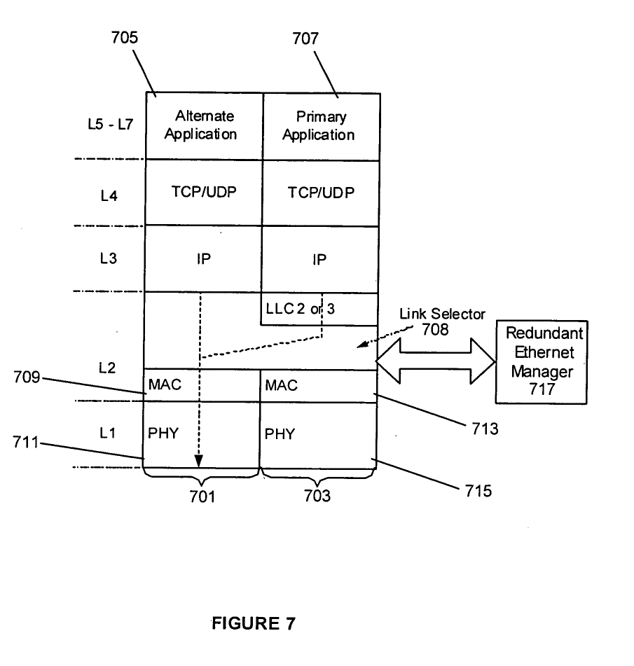

FIG. 7 illustrates the configuration of the stacks and associated components in the case of PHY sharing. As can be seen, a link failure has occurred with respect to communications abilities of the primary stack 703 (layers 3-7). The link selector 708 has routed communications involving the primary stack to the alternate MAC 709 and PHY 711. As discussed above, the multiple IEEE 802.3 MAC PHYs on each station are used for access redundancy in a COTS network. These PHYs also provide link access fault detection to the link selector 708. The link selector 708 ensures that the primary communications stack (for which network redundancy is required) is always assigned to a non-faulted PHY. Applications that do not require redundancy may use a backup PHY and its bound stack. The link selector 708 will overwrite the PHY's factory assigned MAC address with the appropriate primary and backup MAC addresses to use, once the primary PHY is chosen. These MAC addresses may be the original MAC addresses assigned to the PHY.

When the PHY is being shared by two addresses, it may not support two MAC addresses. In this event, as noted above, the PHY should be put into promiscuous mode and pass the MAC address with the packet. Each PHY preferably also indicates to the link selector 708 if there is change in its link status. For example, when the link is restored to the faulted PHY, one of the stacks sharing the PHY will be moved to the restored PHY. In this case, a broadcast packet with the moved MAC address will then be transmitted to inform switches about its availability and location. Once completed, the link selector 708 will also indicate this event to the REM 717.

The REM 717 is loaded with the Ethernet redundant components (link selector, LLC, and MAC PHY) discussed above. The REM 717 will manage and configure the Ethernet redundancy (e.g. the MAC addresses) on the station. For fault management, the REM 717, in conjunction with information from the LLC, link selector, and the MAC PHY, will detect and identify faults and then attempt to diagnose, isolate, and recover from these faults. Fault detection is the identification of an undesirable condition that may result in the loss of network service. Some of these conditions include various statuses (indicated by the MAC PHY, LLC, and Network protocols) such as link (up or down), and end-to-end connectivity. A fault management routine within REM 717 executes when there is a discovery of a fault through direct observation, correlation of fault data, or an inference by observation of other networking behaviors. Once a fault has been detected, a diagnosis is made, such as through the analysis of one or more faults along with other collected data, to determine the nature and location of a problem. Isolation may be needed to contain the problem and keep it from spreading throughout network. To recover from the fault, various actions to resolve the problem are initiated (e.g. switching to the standby port) as discussed above. In addition, the fault management routine of the REM 717 preferably notifies the system or an administrator of the diagnosis made and action taken. As a result, manual or automated replacements of hardware and/or software components may be made as necessary.

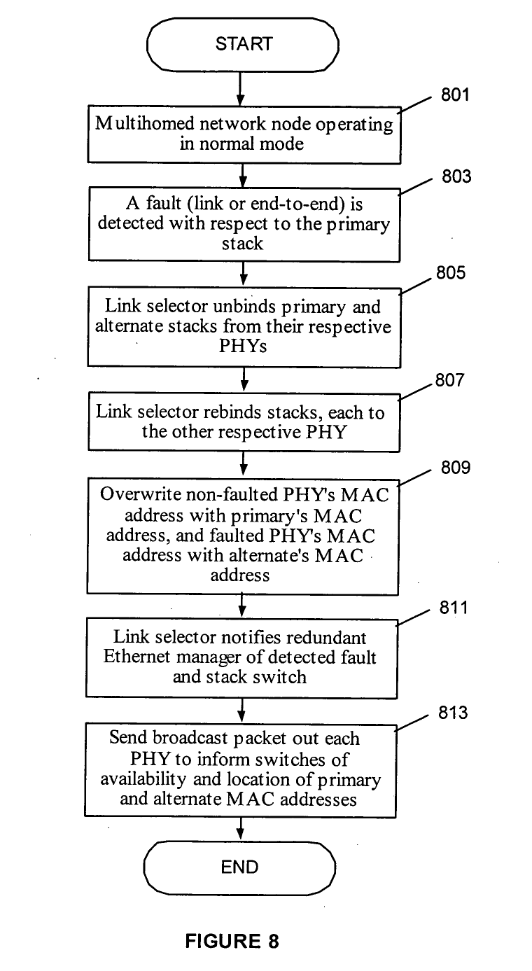

FIG. 8 illustrates a flow chart of steps taken in an embodiment of the invention to facilitate fault remediation. At stage 801, a multihomed network node such as a workstation, control processor, or field communications module, is operating in a normal mode, with a primary application using a primary stack to communicate over a primary MAC/PHY, and an alternate application using the alternate stack to communicate over an alternate MAC/PHY.

At step 803, a fault (link or end-to-end) is detected with respect to the primary stack. Accordingly at step 805, the link selector unbinds the primary and alternate stacks from their respective PHYs. Next, at step 807, the stacks are rebound by the link selector to the other respective PHY. The non-faulted PHY's MAC address is then overwritten with the primary's MAC address in step 809, and the faulted PHY's MAC address is overwritten with the alternate's MAC address. Once the stacks have been switched and the MAC addresses assigned to the appropriate PHYs, the link selector may notify the redundant Ethernet manager of the detected fault and the stack switch as in step 811. Finally, at step 813 a broadcast packet is sent out each PHY to inform switches about the availability and location of the primary and alternate MAC addresses.

It will be appreciated that the Ethernet redundancy solution described above offers many advantages in embodiments of the invention, including providing end-to-end industrial redundant link connectivity using commercial COTS network components and equipment, using alternative links and paths on the same network for redundancy, providing automatic recovery, providing compatibility with standard or proprietary network protocols, providing interoperability to end-stations that are not using this particular Ethernet redundancy solution, allowing applications to write to the standard APIs (such as Berkley socket interfaces), allowing manual switchover such as by an administrator, allowing alternate (non-primary) stacks to also have link redundancy, and allowing multiple stacks can share the same PHY.

However, the structures, techniques, and benefits discussed above are related to the described exemplary embodiments of the invention. In view of the many possible embodiments to which the principles of this invention may be applied, it should be recognized that the embodiments described herein with respect to the drawing figures are meant to be illustrative only and should not be taken as limiting the scope of invention. For example, those of skill in the art will recognize that some elements of the illustrated embodiments shown in software may be implemented in hardware and vice versa or that the illustrated embodiments can be modified in arrangement and detail without departing from the spirit of the invention. Moreover, those of skill in the art will recognize that although Ethernet has been discussed herein as an exemplary network type for implementation of embodiments of the invention, the disclosed principles are widely applicable to other network types as well. Therefore, the invention as described herein contemplates all such embodiments as may come within the scope of the following claims and equivalents thereof.

We claim:

1. An industrial network redundancy system for providing communications redundancy between industrial network nodes comprising:
at least two industrial network nodes, each having a plurality of network ports to a switched network;
a plurality of communications paths between respective network ports of the at least two industrial nodes, wherein the plurality of communication paths comprise the switched network; and
a respective data link protocol layer residing on each of the at least two industrial network nodes for determining which of the plurality of communications paths to utilize for outgoing communications and for determining to which port of the other of the at least two industrial network nodes such communications should be addressed.

2. An industrial network redundancy system for providing communications redundancy between a first industrial network node and a plurality of second industrial network nodes comprising:
the first industrial network node and the plurality of second industrial network nodes, each having a plurality of network ports to a switched network;
a plurality of communications paths between respective network ports of the first industrial network node and each of the plurality of second industrial network nodes, all of the plurality of communication paths comprising the switched network; and
a respective data link protocol layer residing on the first industrial network node and each of the plurality of second industrial network nodes wherein the plurality of communications paths are switched based on detection of a fault in connectivity between nodes.

3. An industrial network node comprising:
a plurality of network ports connected to a single switched network, wherein a second industrial network node is also connected to the switched network; and
a data link protocol layer transparently usable by higher layers of a protocol stack to facilitate network communications to the second industrial network node, the data link protocol layer being adapted to determine which of the plurality of network ports to use to transmit a communication to the second industrial network node, and to forward communications received on any of the plurality of network ports.

4. The industrial network node according to claim 3 wherein each industrial network node comprises a communication end-station.

5. The industrial network node according to claim 4 wherein the communication end-station is selected from the group consisting of a computer, a field module, and a control module.

6. The industrial network node according to claim 3 wherein the higher protocol stack layers above the data link layer include an IP layer.

7. The industrial network node according to claim 6 wherein the higher protocol stack layers above the data link layer include an application layer.

8. The industrial network node according to claim 3 wherein the switched network further comprises at least one IEEE 802.1d compliant bridge.

9. The industrial network node according to claim 3 wherein in determining which of the plurality of network ports to use to transmit a communication to the second industrial network node, the data link protocol layer employs an alternate port based on physical link status information received from its ports and end-to-end connectivity status received from a reliable Logical Link Control (LLC) Type 2 or 3.

10. The industrial network node according to claim 3, wherein the plurality of network ports conform to an IEEE 802.3 link aggregation standard.

11. A method of providing network communication redundancy between a first and second node connected via a switched industrial network, the first and second node each having at least two physical network ports, wherein for each node, one physical port is a primary port associated with a primary communications stack and the other physical port is an alternate port, the method comprising:
determining at the first node that a communications fault has occurred on that node's primary port;
unbinding the primary communications stack from the primary port at the first node transparently to communications stack layers above a data link layer;
binding the primary communications stack to the alternate port at the first node transparently to communications stack layers above the data link layer; and
forwarding further outgoing network communications associated with the primary communications stack from the alternate port of the first node.

12. The method according to claim 11, wherein each physical network port of the first node has a distinct network and MAC address within the switched network.

13. The method according to claim 12, further comprising the step of transmitting a broadcast packet from the first node via the alternate port to inform network switches of the MAC address of the alternate port.

14. The method according to claim 11, wherein the primary port and alternate port of the first node are connected to the switched network via different network switches.

15. The method according to claim 11, wherein the primary port and the alternate port conform to an IEEE 802.3 link aggregation standard.

16. The method according to claim 11, wherein the first and second nodes are each of a type selected from the group consisting of a computer, a field module, and a control module.

17. The method according to claim 11, wherein the communications stack layers above the data link layer include an IP layer.

18. The method according to claim 11, wherein the communications stack layers above the data link layer include an application layer.

19. The method according to claim 11, wherein the switched industrial network further comprises at least one IEEE 802.1d compliant bridge.
